(19) United States
(12) Patent Application Publication
(10) Pub. No.: US 2026/0116237 A1
(43) Pub. Date: Apr. 30, 2026

(54) VEHICLE FUEL CELL PARK ENERGY RESERVE OPERATIONAL STRATEGY

(71) Applicant: FCA US LLC, Auburn Hills, MI (US)

(72) Inventors: Magdalena Krasny, Auburn Hills, MI (US); Jacob Belin, Auburn Hills, MI (US); Rudolf Kharpuri, Auburn Hills, MI (US); Marc S Reischmann, Auburn Hills, MI (US); Andrew M Huisjen, Auburn Hills, MI (US)

(21) Appl. No.: 18/932,686

(22) Filed: Oct. 31, 2024

(51) Int. Cl. B60L 53/62; B60L 50/75; B60L 53/51; B60L 58/40; H01M 8/04223; H01M 8/04225; H01M 8/04302; H01M 8/0432; H01M 8/0444; H01M 8/04537; H01M 8/04664; H01M 10/44; H01M 10/46; H01M 16/00; H02J 7/00; H02J 7/34

(52) U.S. Cl. CPC B60L 53/62; B60L 50/75; B60L 53/51; B60L 58/40; H01M 8/04225; H01M 8/04253; H01M 8/04302; H01M 8/0432; H01M 8/04447; H01M 8/04626; H01M 8/04686; H01M 10/443; H01M 10/46; H01M 16/006; H02J 7/34; H02J 7/933; B60L 2240/12; H01M 2220/20; H01M 2250/20; H01M 2250/402

(57) ABSTRACT

A park energy reserve feature for a fuel cell electric vehicle (FCEV) includes detecting a key-off event indicative of a powerdown of the FCEV and, in response thereto, determining whether a set of conditions for enablement of a park energy reserve feature of a fuel cell power system (FCPS) of the FCEV are satisfied, where the FCPS comprises a hydrogen (H2) fuel cell stack that is configured to selectively generate electrical energy for recharging a high voltage battery system of the FCEV. When satisfied, the park energy reserve feature is executed by extending operation of the FCPS to recharge a high voltage battery system to a desired state of charge (SOC) level that includes an amount of reserve SOC for operating the FCEV without the use of the FCPS during a subsequent startup procedure of the FCPS and, thereafter, completing a shutdown procedure of the FCEV.

### FIELD

The present application generally relates to fuel cell electric vehicles (FCEVs) and, more particularly, to a fuel cell park energy reserve operational strategy for FCEVs.

### BACKGROUND

A fuel cell electric vehicle (FCEV) comprises an electrochemical fuel cell system that generates electricity using a fuel (e.g., hydrogen, or H2). When H2 is combined with oxygen (from air), it produces electrical energy with only heat and water as byproducts. In FCEVs, the fuel cell system operates a secondary power source for periodically providing electrical energy to recharge a high voltage battery pack or system. Under peak load conditions, the high voltage battery system could be depleted below a critical level prior to a shutdown or key-off cycle. In such cases, a customer will have to wait until the fuel cell system startup is complete upon a subsequent key cycle before being able to drive the FCEV. Due to the presence of water in the fuel cell system, there is also the potential for freezing and, in turn, extended startup times for the fuel cell system. This could cause customer dissatisfaction (due to excessive startup times) as well as fuel cell system durability concerns (due to excessive startup/shutdown cycling). Accordingly, while such conventional fuel cell control systems do work for their intended purpose, there exists an opportunity for improvement in the relevant art.

### SUMMARY

According to one example aspect of the invention, a fuel cell park energy reserve system for a fuel cell electric vehicle (FCEV) is presented. In one exemplary implementation, the fuel cell park energy reserve comprises a fuel cell power system (FCPS) of the FCEV, wherein the FCPS comprises a hydrogen (H2) fuel cell stack that is configured to selectively generate electrical energy for recharging a high voltage battery system of the FCEV and a control system configured to detect a key-off event indicative of a powerdown of the FCEV, in response to detecting the key-off event, determine whether a set of conditions are satisfied, wherein the set of conditions are each for enablement of a park energy reserve feature of the FCPS, when the set of conditions are satisfied, execute the park energy reserve feature by extending operation of the FCPS to recharge the high voltage battery system to a desired state of charge (SOC) level, wherein the desired SOC level includes an amount of reserve SOC for operating the FCEV without the use of the FCPS during a subsequent startup procedure of the FCPS, and completing a shutdown procedure of the FCEV after completion of the park energy reserve feature.

In some implementations, the desired SOC level for the park energy reserve feature is based on an ambient temperature. In some implementations, the subsequent startup procedure of the FCPS is a cold start procedure where the ambient temperature is less than an ambient temperature threshold. In some implementations, the ambient temperature threshold corresponds to a likelihood of freezing occurring in the FCPS.

In some implementations, the set of conditions comprise at least one of (i) no faults or malfunctions of the FCEV, (ii) no firmware over-the-air (FOTA) update being requested by the FCEV, (iii) no plant mode or service mode of the FCEV being enabled, (iv) no user inhibiting of the park energy reserve feature, (v) sufficient H2 being present in the FCPS for operation of the park energy reserve feature, and (vi) the SOC of the high voltage battery system being below an SOC threshold level for the park energy reserve feature. In some implementations, the set of conditions comprise (i) no faults or malfunctions of the FCEV, (ii) no FOTA update being requested by the FCEV, (iii) no plant mode or service mode of the FCEV being enabled, (iv) no user inhibiting of the park energy reserve feature, (v) sufficient H2 being present in the FCPS for operation of the park energy reserve feature, and (vi) the SOC of the high voltage battery system being below the SOC threshold level for the park energy reserve feature.

In some implementations, the control system is further configured to not execute the park energy reserve feature when an H2 refueling event of the FCEV is requested or in progress. In some implementations, the control system is further configured to not execute the park energy reserve feature when the FCEV is plugged-in for recharging of the high voltage battery system. In some implementations, a power request for the FCPS during the park energy reserve feature execution is a same power request as during normal operation of the FCPS. In some implementations, the power request for the FCPS during the park energy reserve feature execution is different than a power request for the FCPS during an after-run procedure for the FCPS.

According to another example aspect of the invention, a method of operating a park energy reserve feature for an FCEV is presented. In one exemplary implementation, the method comprises controlling, by a control system of the FCEV, an FCPS of the FCEV, wherein the FCPS comprises a hydrogen (H2) fuel cell stack that is configured to selectively generate electrical energy for recharging a high voltage battery system of the FCEV, detecting, by the control system, a key-off event indicative of a powerdown of the FCEV, in response to detecting the key-off event, determining, by the control system, whether a set of conditions are satisfied, wherein the set of conditions are each for enablement of a park energy reserve feature of the FCPS, when the set of conditions are satisfied, executing, by the control system, the park energy reserve feature by extending operation of the FCPS to recharge the high voltage battery system to a desired state of charge (SOC) level, wherein the desired SOC level includes an amount of reserve SOC for operating the FCEV without the use of the FCPS during a subsequent startup procedure of the FCPS, and completing, by the control system, a shutdown procedure of the FCEV after completion of the park energy reserve feature.

In some implementations, the desired SOC level for the park energy reserve feature is based on an ambient temperature. In some implementations, the subsequent startup procedure of the FCPS is a cold start procedure where the ambient temperature is less than an ambient temperature threshold. In some implementations, the ambient temperature threshold corresponds to a likelihood of freezing occurring in the FCPS.

In some implementations, the set of conditions comprise at least one of (i) no faults or malfunctions of the FCEV, (ii) no FOTA update being requested by the FCEV, (iii) no plant mode or service mode of the FCEV being enabled, (iv) no user inhibiting of the park energy reserve feature, (v) sufficient H2 being present in the FCPS for operation of the park energy reserve feature, and (vi) the SOC of the high voltage battery system being below an SOC threshold level for the park energy reserve feature. In some implementations, the set of conditions comprise (i) no faults or malfunctions of the FCEV, (ii) no FOTA update being requested by the FCEV, (iii) no plant mode or service mode of the FCEV being enabled, (iv) no user inhibiting of the park energy reserve feature, (v) sufficient H2 being present in the FCPS for operation of the park energy reserve feature, and (vi) the SOC of the high voltage battery system being below the SOC threshold level for the park energy reserve feature.

In some implementations, the method further comprises not executing, by the control system, the park energy reserve feature when an H2 refueling event of the FCEV is requested or in progress. In some implementations, the method further comprises not executing, by the control system, the park energy reserve feature when the FCEV is plugged-in for recharging of the high voltage battery system. In some implementations, a power request for the FCPS during the park energy reserve feature execution is a same power request as during normal operation of the FCPS. In some implementations, the power request for the FCPS during the park energy reserve feature execution is different than a power request for the FCPS during an after-run procedure for the FCPS.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a fuel cell electric vehicle (FCEV) having an example park energy reserve system according to the principles of the present application;

FIGS. 2A-2B are a functional block diagram of an example system architecture and an example operational plot for the fuel cell park energy reserve system according to the principles of the present application; and

FIG. 3 is a flow diagram of an example operational method for a park energy reserve strategy for an FCEV according to the principles of the present application.

### DESCRIPTION

As previously discussed, under peak load conditions in a fuel cell electric vehicle (FCEV), a high voltage battery system could be depleted below a critical level prior to a shutdown or key-off cycle. In such cases, a customer will have to wait until the fuel cell system startup is complete upon a subsequent key cycle before being able to drive the FCEV. Due to the presence of water in the fuel cell system, there is also the potential for freezing and, in turn, extended startup times for the fuel cell system. This could cause customer dissatisfaction as well as fuel cell system durability concerns. Accordingly, a park energy reserve operational strategy for FCEVs is presented herein. This strategy involves maintaining or extending a normal fuel cell system run mode after a key-off or ignition-off of the FCEV to replenish the state of charge (SOC) of the high voltage battery system above a calibratable level. Enable conditions for the park energy reserve feature are designed for optimal operating conditions for power generation. The power request is more aligned with a normal fuel cell system run mode compared to a typical fuel cell system after-run feature. The SOC replenishment (i.e., the calibratable level) also accounts for both nominal and cold ambient conditions. Potential benefits include faster FCEV drivability upon key-on or startup and an improved customer experience and/or improved fuel cell system durability and decreased costs.

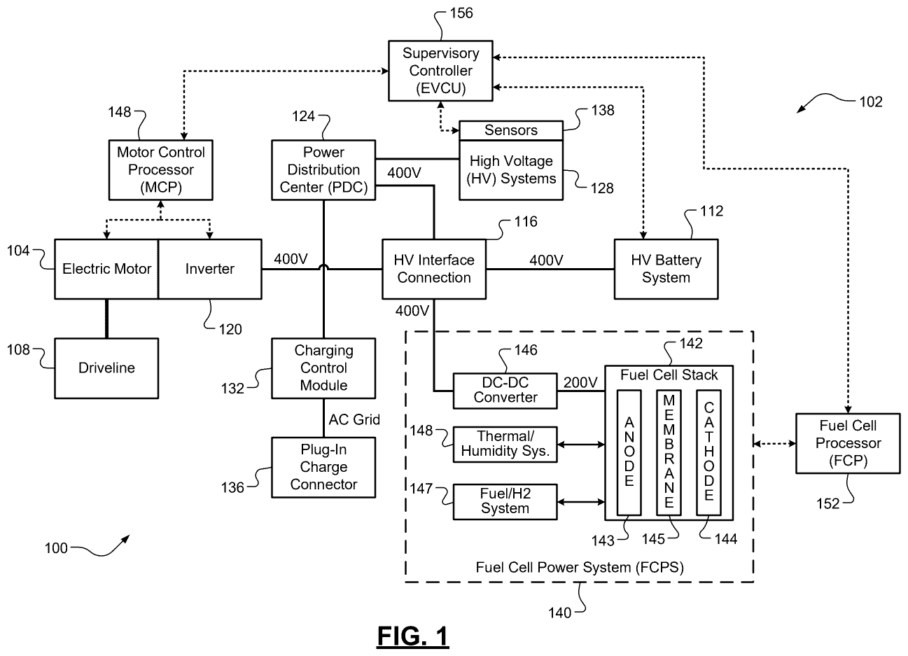

Referring now to FIG. 1, a diagram of a FCEV 100 having an example fuel cell park energy reserve system 102 according to the principles of the present application is illustrated. In one exemplary implementation, the FCEV 100 is a pickup truck automobile, but it will be appreciated that the FCEV 100 could be any other type of passenger automobile or other vehicle. The FCEV 100 is controlled by a supervisory controller (EVCU) 156 and comprises one or more electric motors 104 (e.g., a three-phase electric traction motor) configured to generate drive torque that is transferred directly or via a transmission (not shown) to a driveline 108 of the FCEV 100 or to generate regenerative power by converting mechanical energy from the driveline 108. The EVCU 156 can be configured to perform the periodic fuel cell system wakeup and conditioning as discussed in greater detail herein. The electric motor 104 connected to a high voltage (HV) DC bus and to a HV battery system 112 (a HV battery pack, a battery pack control module (BPCM), HV contactors, etc.) via a HV interface connection 116 and a three-phase inverter 120, which are controlled by an MCP 148. While the HV DC bus is shown to be 400V DC, it will be appreciated that the FCEV 100 could be powered by a different HV DC power magnitude (e.g., 800V DC).

The HV DC bus is also connected to a power distribution center (PDC) 124, which is connected to other HV systems 128 (an electric air compressor, one or more electric heaters, etc.) and also to a charging control module 132 (e.g., an on-board charging or integrated dual charging module, or OBCM/IDCM). The charging control module 132 is selectively connectable to external alternating current (AC) power, such as an AC grid or charging station, via a plug-in charge connector 136. A fuel cell system, or “fuel cell power system” (FCPS) 140, comprises a fuel cell (FC) stack (also “FCS”) 142 (e.g., a hydrogen, or H2 FCS) configured to perform a chemical reaction to generate and output another different HV DC power and is controlled by a fuel cell processor (FCP) 152. As shown, the fuel cell stack 142 comprises an anode 143 that circulates the fuel (H2) therethrough using a fuel/H2 system 147 and a cathode 143 that circulates oxygen (from air) therethrough and outputs air and water vapor. Thermal/humidity conditioning of the FCPS 140 (the fuel cell stack 142) is controlled by a thermal/humidity system 148 (valves, a fan/radiator, a humidifier, etc.). It will be appreciated that the thermal and humidity control systems could also be separate systems rather than a single system 148 as shown merely for illustrative purposes.

A membrane 145 (e.g., a proton exchange membrane) is arranged between the anode 143 and the cathode 144. While not specifically shown, there each fuel cell of the fuel cell stack 142 could further comprise a gas diffusion layer (not shown) and a catalyst (not shown) on each side where an electrical current (i.e., a flow of electrons) is generated therefrom. While a single cell example of the fuel cell stack 142 is illustrated, it will be appreciated that the fuel cell stack 142 could include a plurality of fuel cells stacked together (e.g., in a sandwich-type configuration using bipolar plates). While this other different HV DC power generated by the fuel cell stack 142 is shown to be 200V, it will be appreciated that the FCPS 140 could be configured to output a lesser or greater HV DC power magnitude. A DC-DC converter 146, which could be part of or separate from the FCPS 140, is configured to step-up or boost the lower HV DC power output by the FCPS 140 (e.g., 200V DC) to the higher HV DC power at the HV interface connection 116 (e.g., 400V DC). The EVCU 156 and the FCP 152 are also configured to execute at least a portion of the periodic fuel cell system wakeup and conditioning techniques of the present application, which will now be described in greater detail below.

The primary objective of the park energy reserve feature is to enable extended operation or run time of the FCPS 140 at optimal operating conditions after a customer key-off or shutdown request until a sufficient amount of reserve energy (SOC) in the high voltage battery system 112 is achieved. This reserve energy or SOC is then usable to support vehicle power requests during startup of the FCPS 140 when available power is limited. This is also critical for cold ambient temperature power requests at key-on or startup. When the high voltage battery system 112 is depleted due to a period of high load operation, the high voltage battery system 112 alone or itself (i.e., without the FCPS 140, which requires a startup procedure period) would not be able to achieve cold start performance targets. Such excessive depletion of the high voltage battery system 112 (e.g., below a critical threshold level) could occur during excessive high load operation where the FCPS 140 is unable to keep up or fully compensate for the high discharge rate of the high voltage battery system 112. As previously mentioned, this also could cause durability concerns for the FCPS 140. For example, cycling of voltage, humidity, and temperature in the FCPS 140 accelerate degradation of the membrane 145, particularly during non-nominal operating conditions.

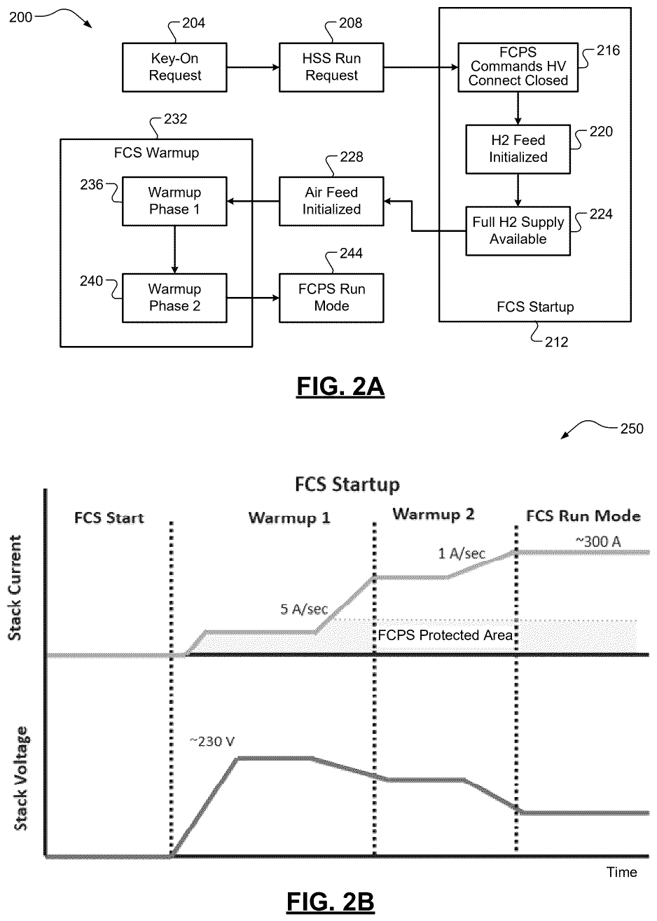

Referring now to FIGS. 2A-2B and with continued reference to FIG. 1, a functional block diagram of example system architectures 200 and an example operational plot 250 for the fuel cell park energy reserve system 102 according to the principles of the present application are illustrated. As shown in architecture 200 of FIG. 2A, a FCPS or FCS startup procedure or routine is illustrated. In response to a key-on or startup request 204 for the FCEV 100 (e.g., an enable request from the EVCU 156 to enable the HV system), the FCPS 140 initiates a run request 208 (e.g., the FCP 152 initiates a hydrogen storage system, or HSS run request). In section 212, the FCS 142 startup occurs, beginning with the FCPS 140 commanding a HV connection closed at 216. Next, at 220, a H2 feed is initiated (e.g., staggering H2 valves open based on a time delay). Finally, at 224, all of the H2 valves are opened and the full H2 supply is available in the FCPS 140. After the FCS 142 startup at 212, an air feed is initialized at 228 (e.g., the FCP 152 commands a compressor on, or to a current greater than zero). In section 232, the FCS 142 warmup occurs, beginning with a first warmup phase 236 where a low humidity target is utilized and a current ramp rate (e.g., 5 amps/second, or A/s) is applied. In a subsequent second warmup phase 240, the low humidity target is maintained and a lower current ramp rate (e.g., 1 A/s) is applied. Finally, at 244, the FCPS 140 enters its run mode (the startup procedure is complete), and a target output power (Tgt Power) is achievable. The plot 250 of FIG. 2B further illustrates the above-described process.

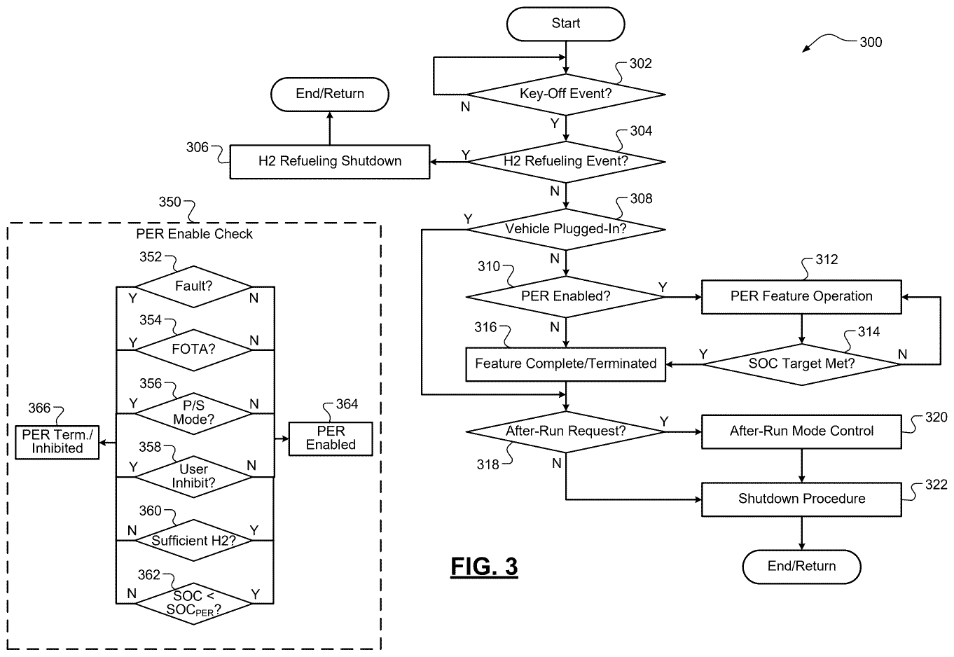

Referring now to FIG. 3 and with continued reference to the previous figures, a flow diagram of an example fuel cell park energy reserve method 300 for a FCEV according to the principles of the present application is illustrated. While the method 300 specifically references the FCEV 100 and its components (e.g., the FCPS 140), it will be appreciated that this method 300 could be applicable to other suitably configured FCEVs. The method 300 begins at 302 where the EVCU 156 determines whether a key-off or vehicle shutdown request has been received (i.e., whether the FCEV 100 is to be powered down). When false, the method 300 ends or returns to 302. When true, the method 300 proceeds to 304. At 304, the ECVU 156 determines whether an H2 refueling event is requested or in process. When true, the method 300 proceeds to 306 where a H2 refueling shutdown occurs, as the FCPS 140 cannot be operating while the H2 refueling process is occurring, and the method 300 then ends. When false, the method 300 proceeds to 308. At 308, the EVCU 156 determines whether the FCEV 100 is currently plugged-in for battery recharging (via the charge connector 136 and the charge control module 132). When true, the method 300 proceeds to 318 as the PER feature cannot run while the FCEV 100 is charging. When false, the method 300 proceeds to 310. At 310, the EVCU 156 determines whether the PER feature is enabled. These enable conditions, as previously discussed, could vary and are designed to provide optimal operating conditions for the PER feature. In one exemplary implementation, the PER feature enablement is determined or checked via process 350.

In 350 as shown, a plurality of conditions 352-362 are each checked to determine whether the PER feature can be enabled at 364 or will be terminated or inhibited at 366. At 352, it is determined whether any faults or malfunctions of the FCEV 100 are present or flagged that would inhibit operation of the PER feature. When true, the PER feature is terminated or inhibited at 366. When false, provided the other conditions are satisfied, the PER feature could be enabled at 364. At 354, it is determined whether a firmware over-the-air (FOTA) update for the FCEV 100 has been requested or a FOTA update is in progress. When true, the PER feature is terminated or inhibited at 366. When false, provided the other conditions are satisfied, the PER feature could be enabled at 364. At 356, it is determined whether a plant (P) mode (during assembly of the FCEV 100) or a service(S) mode (during service of the FCEV 100) is active or enabled. When true, the PER feature is terminated or inhibited at 366. When false, provided the other conditions are satisfied, the PER feature could be enabled at 364. At 358, it is determined whether the customer/driver has inhibit the operation of the PER feature (e.g., via a manual input, such as per their preferences). When true, the PER feature is terminated or inhibited at 366. When false, provided the other conditions are satisfied, the PER feature could be enabled at 364. At 360, it is determined whether there is sufficient H2 for the FCPS 140 to operate for the PER feature. When false, the PER feature is terminated or inhibited at 366. When true, provided the other conditions are satisfied, the PER feature could be enabled at 364. Finally, at 362, it is determined whether the SOC of the high voltage battery system 112 is below a SOC threshold or target (SOCPER) for the PER feature. When false, the PER feature is terminated or inhibited at 366. When true, provided the other conditions are satisfied, the PER feature could be enabled at 364.

When the PER feature is enabled at 310, the method 300 proceeds to 312. Otherwise, the method 300 proceeds to 316. At 312, the EVCU 156 (e.g., in coordination with the FCP 152) executes the PER feature. As previously discussed, this involves extending the operation of the FCPS 140 to generate energy/SOC reserve at the high voltage battery system 112, with the amount of energy/SOC reserve being primarily based on the ambient temperature. At 314, it is determined whether a target SOC (e.g., a critical SOC level plus the energy/SOC reserve) has been achieved via the extended operation of the FCPS 140. When true, the method 300 proceeds to 316. When false, the method 300 returns to 312 and the PER feature continues until the target SOC is achieved. At 316, the PER feature is terminated (e.g., from step 308) or completed (e.g., from step 314). In some embodiments, after-run of the FCPS 140 could further be requested and executed. At 318, it is determined whether an after-run request for the FCPS 140 has been received. When false, the method 300 proceeds to 322. When true, the method 300 proceeds to 320 where after-run mode control is performed. This after-run procedure, as previously discussed, could greatly differ from the PER feature of the present application. For example, the after-run procedure could utilize a very different power request than the PER feature, which could utilize a power request similar to a normal run of the FCPS 140. At 322, the shutdown procedure of the FCEV 100 is completed by fully shutting down the FCPS 140 and the method 300 then ends or returns to 302 for another one or more cycles during subsequent key-off cycle events.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A fuel cell park energy reserve system for a fuel cell electric vehicle (FCEV), the fuel cell park energy reserve comprising:
a fuel cell power system (FCPS) of the FCEV, wherein the FCPS comprises a hydrogen (H2) fuel cell stack that is configured to selectively generate electrical energy for recharging a high voltage battery system of the FCEV; and
a control system configured to:
detect a key-off event indicative of a powerdown of the FCEV;
in response to detecting the key-off event, determine whether a set of conditions are satisfied, wherein the set of conditions are each for enablement of a park energy reserve feature of the FCPS;
when the set of conditions are satisfied, execute the park energy reserve feature by extending operation of the FCPS to recharge the high voltage battery system to a desired state of charge (SOC) level, wherein the desired SOC level includes an amount of reserve SOC for operating the FCEV without the use of the FCPS during a subsequent startup procedure of the FCPS; and
completing a shutdown procedure of the FCEV after completion of the park energy reserve feature.

2. The fuel cell park energy reserve system of claim 1, wherein the desired SOC level for the park energy reserve feature is based on an ambient temperature.

3. The fuel cell park energy reserve system of claim 2, wherein the subsequent startup procedure of the FCPS is a cold start procedure where the ambient temperature is less than an ambient temperature threshold.

4. The fuel cell park energy reserve system of claim 3, wherein the ambient temperature threshold corresponds to a likelihood of freezing occurring in the FCPS.

5. The fuel cell park energy reserve system of claim 1, wherein the set of conditions comprise at least one of (i) no faults or malfunctions of the FCEV, (ii) no firmware over-the-air (FOTA) update being requested by the FCEV, (iii) no plant mode or service mode of the FCEV being enabled, (iv) no user inhibiting of the park energy reserve feature, (v) sufficient H2 being present in the FCPS for operation of the park energy reserve feature, and (vi) the SOC of the high voltage battery system being below an SOC threshold level for the park energy reserve feature.

6. The fuel cell park energy reserve system of claim 5, wherein the set of conditions comprise (i) no faults or malfunctions of the FCEV, (ii) no FOTA update being requested by the FCEV, (iii) no plant mode or service mode of the FCEV being enabled, (iv) no user inhibiting of the park energy reserve feature, (v) sufficient H2 being present in the FCPS for operation of the park energy reserve feature, and (vi) the SOC of the high voltage battery system being below the SOC threshold level for the park energy reserve feature.

7. The fuel cell park energy reserve system of claim 1, wherein the control system is further configured to not execute the park energy reserve feature when an H2 refueling event of the FCEV is requested or in progress.

8. The fuel cell park energy reserve system of claim 1, wherein the control system is further configured to not execute the park energy reserve feature when the FCEV is plugged-in for recharging of the high voltage battery system.

9. The fuel cell park energy reserve system of claim 1, wherein a power request for the FCPS during the park energy reserve feature execution is a same power request as during normal operation of the FCPS.

10. The fuel cell park energy reserve system of claim 9, wherein the power request for the FCPS during the park energy reserve feature execution is different than a power request for the FCPS during an after-run procedure for the FCPS.

11. A method of operating a park energy reserve feature for a fuel cell electric vehicle (FCEV), the method comprising:
controlling, by a control system of the FCEV, a fuel cell power system (FCPS) of the FCEV, wherein the FCPS comprises a hydrogen (H2) fuel cell stack that is configured to selectively generate electrical energy for recharging a high voltage battery system of the FCEV;
detecting, by the control system, a key-off event indicative of a powerdown of the FCEV;
in response to detecting the key-off event, determining, by the control system, whether a set of conditions are satisfied, wherein the set of conditions are each for enablement of a park energy reserve feature of the FCPS;
when the set of conditions are satisfied, executing, by the control system, the park energy reserve feature by extending operation of the FCPS to recharge the high voltage battery system to a desired state of charge (SOC) level, wherein the desired SOC level includes an amount of reserve SOC for operating the FCEV without the use of the FCPS during a subsequent startup procedure of the FCPS; and
completing, by the control system, a shutdown procedure of the FCEV after completion of the park energy reserve feature.

12. The method of claim 11, wherein the desired SOC level for the park energy reserve feature is based on an ambient temperature.

13. The method of claim 12, wherein the subsequent startup procedure of the FCPS is a cold start procedure where the ambient temperature is less than an ambient temperature threshold.

14. The method of claim 13, wherein the ambient temperature threshold corresponds to a likelihood of freezing occurring in the FCPS.

15. The method of claim 11, wherein the set of conditions comprise at least one of (i) no faults or malfunctions of the FCEV, (ii) no firmware over-the-air (FOTA) update being requested by the FCEV, (iii) no plant mode or service mode of the FCEV being enabled, (iv) no user inhibiting of the park energy reserve feature, (v) sufficient H2 being present in the FCPS for operation of the park energy reserve feature, and (vi) the SOC of the high voltage battery system being below an SOC threshold level for the park energy reserve feature.

16. The method of claim 15, wherein the set of conditions comprise (i) no faults or malfunctions of the FCEV, (ii) no FOTA update being requested by the FCEV, (iii) no plant mode or service mode of the FCEV being enabled, (iv) no user inhibiting of the park energy reserve feature, (v) sufficient H2 being present in the FCPS for operation of the park energy reserve feature, and (vi) the SOC of the high voltage battery system being below the SOC threshold level for the park energy reserve feature.

17. The method of claim 11, further comprising not executing, by the control system, the park energy reserve feature when an H2 refueling event of the FCEV is requested or in progress.

18. The method of claim 11, further comprising not executing, by the control system, the park energy reserve feature when the FCEV is plugged-in for recharging of the high voltage battery system.

19. The method of claim 11, wherein a power request for the FCPS during the park energy reserve feature execution is a same power request as during normal operation of the FCPS.

20. The method of claim 19, wherein the power request for the FCPS during the park energy reserve feature execution is different than a power request for the FCPS during an after-run procedure for the FCPS.
